(19) United States
(12) Patent Application Publication
(10) Pub. No.: US 2016/0292730 A1
(43) Pub. Date: Oct. 6, 2016

(54) SYSTEM, METHOD, AND PLATFORM FOR USER GENERATED ADVERTISING CAMPAIGN

(71) Applicant: Michael Leander Perry, San Francisco, CA (US)

(72) Inventor: Michael Leander Perry, San Francisco, CA (US)

(21) Appl. No.: 14/679,853

(22) Filed: Apr. 6, 2015

(51) Int. Cl. G06Q 30/02; G06Q 50/00

(52) U.S. Cl. CPC G06Q 30/0255; G06Q 30/0249; G06Q 50/01; G06Q 30/0277; G06Q 30/0276

(57) ABSTRACT

An electronic portal provides merchant users facilitated generation of advertising campaigns via text messaging. A merchant user may initiate an advertising campaign by text messaging the portal. In response to options provided by the portal, the merchant user selects a product as the subject of the campaign. In some embodiments, a budget may be selected to limit the number of advertisements generated. A platform connected to the portal may include a database of online shopping activity from previous customers of the merchant user and of potential new customers identified by data mining of social media sites. The platform may generate the advertising campaign based on the merchant user's inputs and identified potential customers sending advertisements related to the product the identified potential customers.

### BACKGROUND

The embodiments herein relate generally to advertising, and more particularly to a user generated advertising campaign.

Conventional advertising through online mediums requires accessing a website and establishing the parameters of the campaign using for example keywords and other user selected criteria. The criteria are used by an algorithm to provide advertisements on an unknown number of web locations if for example, the criteria matches data found on a webpage. Advertisements may commonly be irrelevant to the actual page landed on. The process is convoluted for many business owners and may be highly inefficient in reaching a desirable target base. In addition, the process may be time consuming as sometimes many metrics are presented to the user to predict how well the advertisement will perform.

As can be seen there is a need for generating advertising campaigns that are easy for a merchant to establish and will reach targeted customer bases.

### SUMMARY

According to one embodiment of the subject technology, a computer program product for generating a user defined electronic advertising campaign, the computer program product comprising a non-transitory computer readable storage medium having computer readable program code embodied therewith, the computer readable program code being configured to, when executed by a computer processor: provide an electronic portal accessed via a mobile computing device; receive, from a merchant user, a first text message request on the electronic portal for an electronic advertising campaign; receive, via a second text message, a product identified as a subject of the electronic advertising campaign; identify potential customers based on stored online shopping activity of a customer base associated with the merchant user; and publish an electronic advertisement associated with the identified product to electronic accounts of the identified potential customers.

According to another embodiment of the subject technology a processor comprises computer readable non-transitory memory having computer readable program code executed thereon, the computer readable program code being configured to: provide an electronic portal accessed via a mobile computing device; receive, from a merchant user, a first text message request on the electronic portal for an online advertising campaign; receive, via a second text message, a product identified as a subject of the electronic advertising campaign; identify potential customers based on stored online shopping activity of a customer base associated with the merchant user; and publish an electronic advertisement associated with the identified product to electronic accounts of the identified potential customers.

### BRIEF DESCRIPTION OF THE FIGURES

The detailed description of some embodiments of the present invention is made below with reference to the accompanying figures, wherein like numerals represent corresponding parts of the figures.

FIG. 1 is a block diagram of a general computing device according to an exemplary embodiment of the subject technology;

FIG. 2 is a block diagram of an online network according to an exemplary embodiment of the subject technology;

FIG. 3 is a flowchart of a method for generating a user defined online marketing campaign according to an exemplary embodiment of the subject technology.

### DETAILED DESCRIPTION OF CERTAIN EMBODIMENTS

Broadly embodiments of the subject technology provide an online platform that automatically generates an electronic advertising campaign via text message requests from a merchant user. A merchant user may establish an account with the platform and may register products that may be the subject of electronic advertisements. The merchant user may also provide the platform with access to electronic marketplace applications the merchant engages in selling merchandise through. The platform may store online shopping activity related to products sold by the merchant user through the electronic marketplace applications. The platform may also data mine social media sites for online shopping activity related to products sold by the merchant user. The platform may use the stored online shopping activity of the merchant's previous customers and that learned by the data mining of social media sites to build up a database of potential customers relevant to the merchant user's registered products.

A merchant user may initiate an advertising campaign by text messaging an electronic portal operated by the platform. In response to options provided by the portal, the merchant user selects a product as the subject of the campaign. The platform may generate the advertising campaign for the product and send electronic advertisements identified potential customers related to the product. As may be appreciated, aspects of the subject technology may be run on one or more computing devices as described in more detail below.

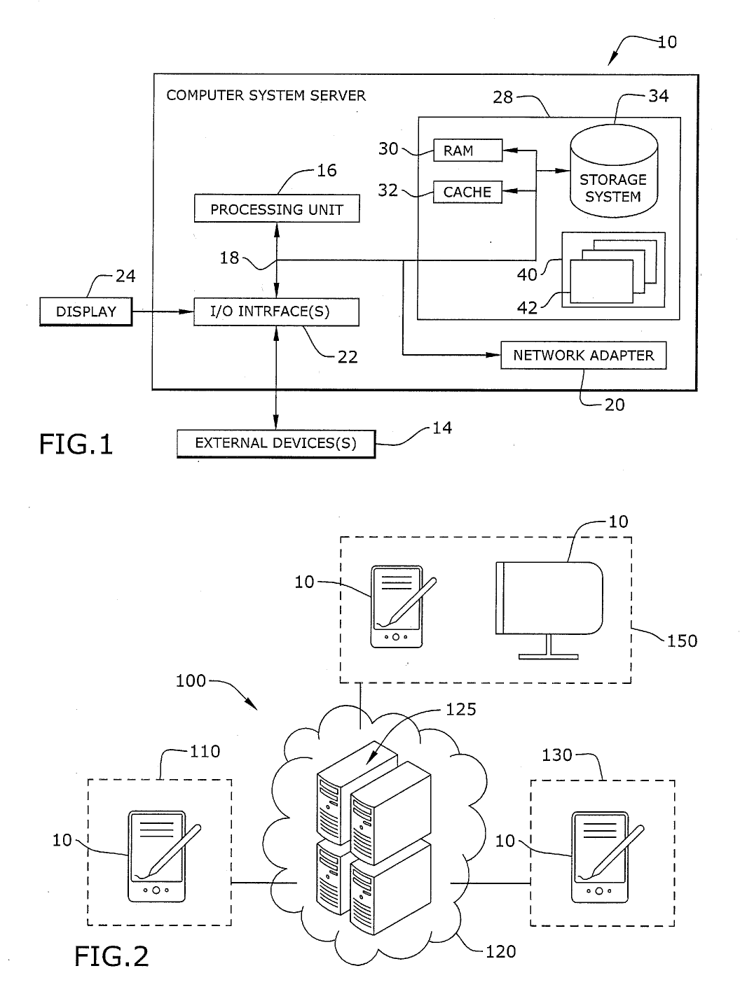

Referring now to FIG. 1, a schematic of an example of a computer system/server 10 is shown. The computer system/server 10 is shown in the form of a general-purpose computing device. The computer system/server 10 may represent a machine implementing software based aspects of the subject technology. In some instances, the computer system/server 10 may represent the machine for operating the platform. In some instances, the computer system/server 10 may represent a machine for communicating with the platform (for example a mobile device with text messaging capability). The components of the computer system/server 10 may include, but are not limited to, one or more processors or processing units 16, a system memory 28, and a bus 18 that couples various system components including the system memory 28 to the processor 16.

The computer system/server 10 may be for example, smart phones, tablet devices, handheld or laptop devices, multiprocessor systems, server computer systems, personal computer systems, microprocessor-based systems, set top boxes, programmable consumer electronics, network PCs, and distributed cloud computing environments that include any of the above systems or devices, and the like. The computer system/server 10 may be described in the general context of computer system executable instructions, such as program modules, being executed by a computer system (described for example, below).

The computer system/server 10 may typically include a variety of computer system readable media. Such media could be chosen from any available media that is accessible by the computer system/server 10, including non-transitory, volatile and non-volatile media, removable and non-removable media. The system memory 28 could include one or more computer system readable media in the form of volatile memory, such as a random access memory (RAM) 30 and/or a cache memory 32. By way of example only, a storage system 34 can be provided for reading from and writing to a non-removable, non-volatile magnetic media device typically called a “hard drive” (not shown).

The system memory 28 may include at least one program product 40 having a set of program modules 42 that are configured to carry out the functions of embodiments of the subject technology. The program product/utility 40, having a set (at least one) of program modules 42, may be stored in the system memory 28, as well as an operating system, one or more application programs, other program modules, and program data. Each of the operating system, one or more application programs, other program modules, and program data or some combination thereof, may include an implementation of a networking environment. The program modules 42 generally carry out the functions and/or methodologies of embodiments of the invention as described herein. For example, the program modules 42 may carry out steps related to: establishing a merchant user account; registering products associated with the merchant user; accessing electronic marketplace applications the merchant user sells products through; data mining product sales related information through the electronic marketplace applications; accessing social media sites; data mining product related information from the social media sites; identifying potential customers from the electronic marketplace applications and social media sites; storing mined information; establishing a database of merchant users and associated information; providing an electronic portal for communicating through text messaging; providing queries to merchant users for use in generating parameters for an advertising campaign; and transmitting electronic advertisements to potential customers.

The computer system/server 10 may also communicate with one or more external devices 14 such as a keyboard, a pointing device, a display 24, etc.; and/or any devices (e.g., network card, modem, etc.) that enable the computer system/server 10 to communicate with one or more other computing devices. Such communication can occur via Input/Output (I/O) interfaces 22. Alternatively, the computer system/server 10 can communicate with one or more networks such as a local area network (LAN), a general wide area network (WAN), and/or a public network (e.g., the Internet) via a network adapter 20. As depicted, the network adapter 20 may communicate with the other components of the computer system/server 10 via the bus 18.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the disclosed invention may take the form of a computer program product embodied in one or more computer readable media having computer readable program code embodied thereon. Any combination of one or more computer readable media (for example, storage system 34) may be utilized. In the context of this disclosure, a computer readable storage medium may be any tangible or non-transitory medium that can contain, or store a program (for example, the program product 40) for use by or in connection with an instruction execution system, apparatus, or device. A computer readable storage medium may be, for example, but not limited to, an electronic, magnetic, optical, electromagnetic, infrared, or semiconductor system, apparatus, or device, or any suitable combination of the foregoing.

Aspects of the disclosed invention are described below with reference to block diagrams of methods, apparatus (systems) and computer program products according to embodiments of the invention. It will be understood that each block of the block diagrams, and combinations of blocks in the flowchart illustrations and/or block diagrams, can be implemented by computer program instructions. These computer program instructions may be provided to the processor 16 of a general purpose computer, special purpose computer, or other programmable data processing apparatus to produce a machine, such that the instructions, which execute via the processor of the computer or other programmable data processing apparatus, create means for implementing the functions/acts specified in the flowchart(s) and/or block diagram block or blocks.

Referring now to FIG. 2, a network 100 is shown according to an exemplary embodiment of the present invention. The network 100 may include a sender side 110 and a receiver side 130 connected to one another by a telecommunications network 120 (for example, any combination of telephone, cellular phone, or Internet connections) and server(s) 125. The server(s) 125 may take the form of the computer/server 10. Likewise, the sender side 110 and the receiver side 130 may each comprise one or more computer/servers 10. The sender side 110 may represent a user interface from which a merchant user may initiate and execute a request for an electronic advertising campaign. In an exemplary embodiment, the merchant user may initiate the process by sending a text message from a smart phone or tablet device to the receiver side 130. The receiver side 130 may represent for example, one or more computer systems/servers 10 operating the platform that operates the portal to receive text message requests from merchant users and responds with text message requests that trigger the generation of an electronic advertising campaign. The receiver side 130 may include the operating system for running the platform and database(s) records that the platform operating system accesses for user, product, and customer information. The receiver side 130 may transmit generated advertisements to a third party side 150 which may be identified potential customers. The server(s) 125 may represent an intermediate node for receiving, processing and transmitting data between the sender side 110, the receiver side 130, and the third party side 150.

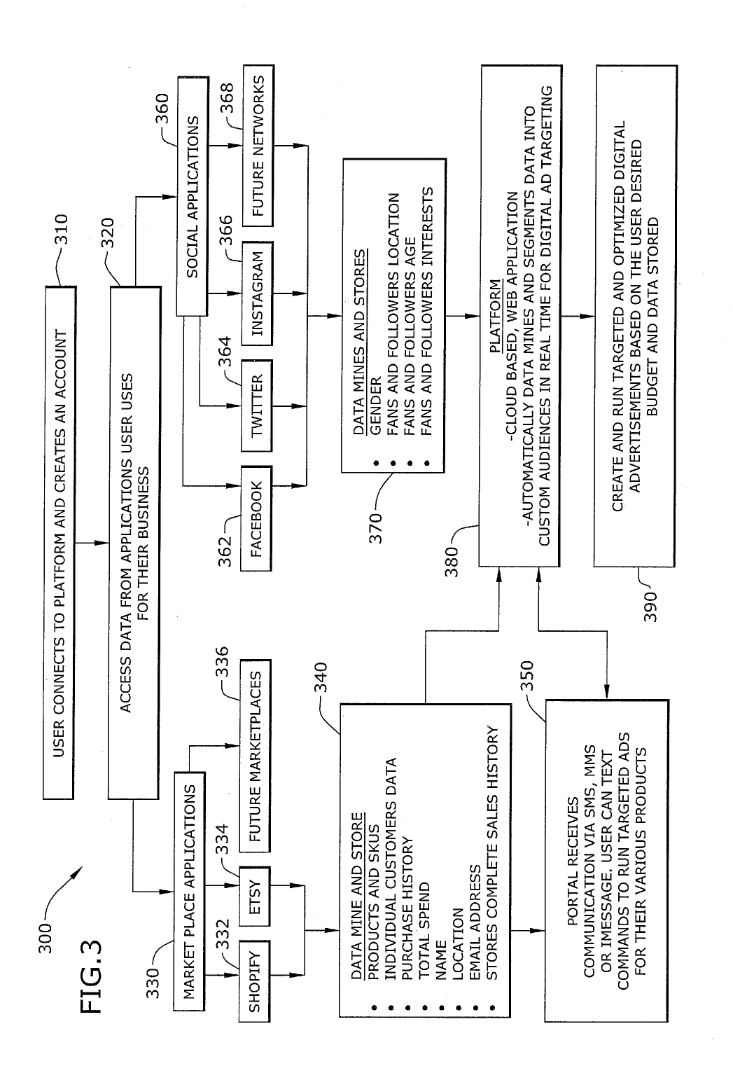

Referring now to FIG. 3, a method 300 for generating a user defined online marketing campaign is shown according to an exemplary embodiment of the subject technology. In block 310 a merchant user may connect to an online platform and create an account. The account may include the merchant user's storefront identification, payment arrangement for initiating advertising campaigns, and a menu of products offered for sale that may be the subject of an electronic advertisement campaign. In block 320, the platform may access electronic applications the merchant user uses to conduct business. The left side of the flowchart represents an established customer base source. Block 330 represents marketplace applications (for example, Shopify 332, Etsy 334, and future marketplaces 336) from which the merchant user sells products. In block 340, the platform may data mine and store online shopping activity from the marketplace applications 330 including products sold and customers who purchased products. The right side of the flowchart represents a potential new customer base. The platform may also access social media sites 360 (for example, Facebook 362, Twitter 364, Instagram 366, and future network sites 368) to data mine and store (block 370) online shopping activity related to users and their shopping preferences/tendencies.

As may be appreciated, aspects of the subject technology may initiate and generate an advertising campaign via text messaging. The merchant user may only need to text message the platform and within a few text message responses, the platform generates the campaign. In block 350, the merchant user may initiate an electronic advertising campaign request by sending a text message to a number representing the online platform's messaging portal. The portal may respond by text message querying which product from the merchant user's stored selection will be the subject of a campaign. Upon selection (via text message by the merchant user), some embodiments may follow-up with a query related to the budget allotted for the campaign. As may be appreciated, the number of advertisements/advertising targets may be limited by the user selected budget so that they campaign remains fiscally responsible. The budget may represent payment to the platform for the service of creating and handling the campaign. In block 380, the platform receives the information from the text messaging and retrieves from its database(s) information related to the product being advertised. The platform identifies potential customers from the information data mined from the marketplace applications and social media sites. In block 390, the platform sends electronic advertisements to electronic accounts of the identified potential customers. The electronic accounts may be for example, e-mail, phone messaging numbers, social media site accounts, marketplace accounts, and IP addresses associated with web browsing.

The word “exemplary” is used herein to mean “serving as an example or illustration.” Any aspect or design described herein as “exemplary” is not necessarily to be construed as preferred or advantageous over other aspects or designs.

Persons of ordinary skill in the art may appreciate that numerous design configurations may be possible to enjoy the functional benefits of the inventive systems. Thus, given the wide variety of configurations and arrangements of embodiments of the present invention the scope of the present invention is reflected by the breadth of the claims below rather than narrowed by the embodiments described above.

What is claimed is:

1. A computer program product for generating a user defined electronic advertising campaign, the computer program product comprising a non-transitory computer readable storage medium having computer readable program code embodied therewith, the computer readable program code being configured to, when executed by a computer processor:
provide an electronic portal for advertising accessed via a mobile computing device;
receive, from a merchant user, a first text message request on the electronic portal for initiating an electronic advertising campaign;
receive, via a second text message, a product identified as a subject of the electronic advertising campaign;
identify potential customers based on stored online shopping activity of a customer base associated with the merchant user; and
publish an electronic advertisement associated with the identified product to electronic accounts of the identified potential customers.

2. The computer program product of claim 1, further comprising computer readable program code being configured to limit publication occurrences of the electronic advertisement based on a marketing budget selected by the merchant user.

3. The computer program product of claim 1, further comprising computer readable program code being configured to provide to the merchant user a menu of products pre-stored in an account associated with the merchant user.

4. The computer program product of claim 3, further comprising computer readable program code being configured to data mine social media sites for online shopping activity of products related to the menu of products pre-stored in the account associated with the merchant user.

5. The computer program product of claim 1, wherein the electronic accounts of the identified potential customers include e-mail accounts and phone messaging numbers.

6. A processor, comprising a computer readable non-transitory memory having computer readable program code executed thereon, the computer readable program code being configured to:
provide an electronic portal accessed via a mobile computing device;
receive, from a merchant user, a first text message request on the electronic portal for an electronic advertising campaign;
receive, via a second text message, a product identified as a subject of the electronic advertising campaign;
identify potential customers based on stored online shopping activity of a customer base associated with the merchant user; and
publish an online advertisement associated with the identified product to electronic accounts of the identified potential customers.

7. The processor of claim 6, further comprising computer readable program code being configured to limit publication occurrences of the electronic advertisement based on a marketing budget selected by the merchant user.

8. The processor of claim 7, further comprising computer readable program code being configured to provide to the merchant user a menu of products pre-stored in an account associated with the merchant user.

9. The processor of claim 6, further comprising computer readable program code being configured to data mine social media sites for online shopping activity of products related to the menu of products pre-stored in the account associated with the merchant user.

10. The processor of claim 6, wherein the electronic accounts of the identified potential customers include e-mail accounts and phone messaging numbers.
